(19) United States
(12) Patent Application Publication
(10) Pub. No.: US 2014/0157186 A1
(43) Pub. Date: Jun. 5, 2014

(54) THREE DIMENSIONAL DESKTOP RENDERING IN A DATA PROCESSING DEVICE

(71) Applicants: Himanshu Jagadish Bhat, Pune (IN); Gautam Pratap Kale, Pune (IN)

(72) Inventors: Himanshu Jagadish Bhat, Pune (IN); Gautam Pratap Kale, Pune (IN)

(21) Appl. No.: 13/691,858

(22) Filed: Dec. 3, 2012

(51) Int. Cl. G06F 3/0481

(52) U.S. Cl. CPC G06F 3/04815
USPC 715/782

(57) ABSTRACT

A method includes initiating, through a display driver component of a processor of a data processing device, acquisition of one or more depth parameter(s) of a window of an application executing on the data processing device and/or a sub-portion of the window. The method also includes determining, through the processor, depth of the window relative to a background desktop surface provided by an operating system executing on the data processing device and/or the sub-portion of the window relative to the window based on the acquired one or more depth parameter(s). Further, the method includes rendering, through the processor, the window and/or the sub-portion of the window in a three dimensional (3D) mode based on the determined relative depth thereof on a display unit of the data processing device.

### FIELD OF TECHNOLOGY

This disclosure relates generally to data processing devices, and more particularly, to three dimensional desktop rendering in a data processing device.

### BACKGROUND

In an attempt to provide for an intuitive user experience on a data processing device (e.g., a laptop, a desktop computer, a tablet, a mobile device), a three dimensional (3D) aware application may execute thereon. In the case of a two dimensional (2D) application executing on the data processing device, a user thereof may not have a same intuitive experience. The user may open a number of application windows on the desktop of the data processing device, and may find it hard to switch between windows and/or distinguish between elements within a window easily. The aforementioned difficulty may contribute to a frustrating user experience.

### SUMMARY

Disclosed are a method, a device and/or a system of three dimensional desktop rendering in a data processing device.

In one aspect, a method includes initiating, through a display driver component of a processor of a data processing device, acquisition of one or more depth parameter(s) of a window of an application executing on the data processing device and/or a sub-portion of the window. The method also includes determining, through the processor, depth of the window relative to a background desktop surface provided by an operating system executing on the data processing device and/or the sub-portion of the window relative to the window based on the acquired one or more depth parameter(s). Further, the method includes rendering, through the processor, the window and/or the sub-portion of the window in a three dimensional (3D) mode based on the determined relative depth thereof on a display unit of the data processing device.

When a number of windows is associated with the application, the method may further include determining, through the processor, an order of arrangement of the number of windows based on depths thereof relative to the background desktop surface, and rendering, through the processor, one or more of the number of windows in the 3D mode based on the determined order of arrangement of the number of windows on the display unit of the data processing device. The method may also include rendering, through the processor, the sub-portion of the window at a depth different from a remaining portion of the window.

The method may also include rendering, through the processor, an application view associated with the window and another application view associated with another window into separate buffer sets, and compositing, through the processor, the separate buffer sets together through the operating system in conjunction with the display driver component. The rendering of the window and/or the sub-portion of the window in the 3D mode may include distinguishing between a boundary of the window, a boundary of another window and a boundary of the background desktop surface, and/or distinguishing between a boundary of the sub-portion of the window and a boundary of another sub-portion of the window.

The method may further include providing, through a user interface of the operating system, the application and/or the data processing device, a capability to a user of the data processing device to turn on and/or turn off the rendering of the window and/or the sub-portion of the window in the 3D mode and/or control the determined relative depth to be rendered in the 3D mode. Further, the method may include providing, through the display driver component, a capability to a user of the data processing device to view the window and/or the sub-portion of the window with 3D glasses. The initiation of the acquisition of the one or more depth parameter(s) may include invoking, through the display driver component, a library file stored in a memory of the data processing device and/or instructing, through the operating system, the display driver component through one or more Application Programming Interface(s) (API(s)) and/or Display Driver Interface(s) (DDI(s)) to enable the rendering of the window and/or the sub-portion thereof in the 3D mode. The library file is associated with enabling the rendering of the window and/or the sub-portion thereof in the 3D mode.

In another aspect, a non-transitory medium, readable through a data processing device and including instructions embodied therein that are executable through the data processing device, is disclosed. The non-transitory medium includes instructions to initiate, through a display driver component of a processor of the data processing device, acquisition of one or more depth parameter(s) of a window of an application executing on the data processing device and/or a sub-portion of the window. The non-transitory medium also includes instructions to determine, through the processor, depth of the window relative to a background desktop surface provided by an operating system executing on the data processing device and/or the sub-portion of the window relative to the window based on the acquired one or more depth parameter(s). Further, the non-transitory medium includes instructions to render, through the processor, the window and/or the sub-portion of the window in a 3D mode based on the determined relative depth thereof on a display unit of the data processing device.

The non-transitory medium may further include instruction to execute supplementary operations discussed above.

In yet another aspect, a data processing device includes a memory, a processor communicatively coupled to the memory, and a display driver component of the processor. The display driver component of the processor is configured to initiate acquisition of one or more depth parameter(s) of a window of an application executing on the data processing device and/or a sub-portion of the window. The processor is configured to determine depth of the window relative to a background desktop surface provided by an operating system executing on the data processing device and/or the sub-portion of the window relative to the window based on the acquired one or more depth parameter(s), and to render the window and/or the sub-portion of the window in a 3D mode based on the determined relative depth thereof on a display unit of the data processing device.

Elements of the data processing device may also be configured to perform supplementary operations discussed above.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a schematic view of a data processing device, according to one embodiment.

FIG. 2 is a schematic view of a number of application windows rendered in a three dimensional (3D) stereo mode in the data processing device of FIG. 1, according to one embodiment.

FIG. 3 is a schematic view of rendering example application view(s) associated with application window(s) on the data processing device of FIG. 1.

FIG. 4 is a schematic view of distinguishing between boundaries of application window(s) and a boundary of a background desktop surface and between boundaries of sub-portion(s) of an application window in the data processing device of FIG. 1, according to one embodiment.

FIG. 5 is a schematic view of a user interface provided by an application and/or an operating system executing on the data processing device of FIG. 1, according to one or more embodiments.

FIG. 6 is a schematic view of a user of the data processing device of FIG. 1 viewing an application window and/or a sub-portion thereof using 3D glasses.

FIG. 7 is a schematic view of an example alternate implementation of rendering an application window and/or a sub-portion thereof in a 3D mode in the data processing device of FIG. 1.

FIG. 8 is a schematic view of interaction between a display driver component and a processor of the data processing device of FIG. 1, according to one or more embodiments.

FIG. 9 is a process flow diagram detailing the operations involved in 3D desktop rendering in the data processing device of FIG. 1, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of three dimensional desktop rendering in a data processing device. Although the present embodiments have been described with reference to specific example embodiments, it will be evident that various modifications and changes may be made to these embodiments without departing from the broader spirit and scope of the various embodiments.

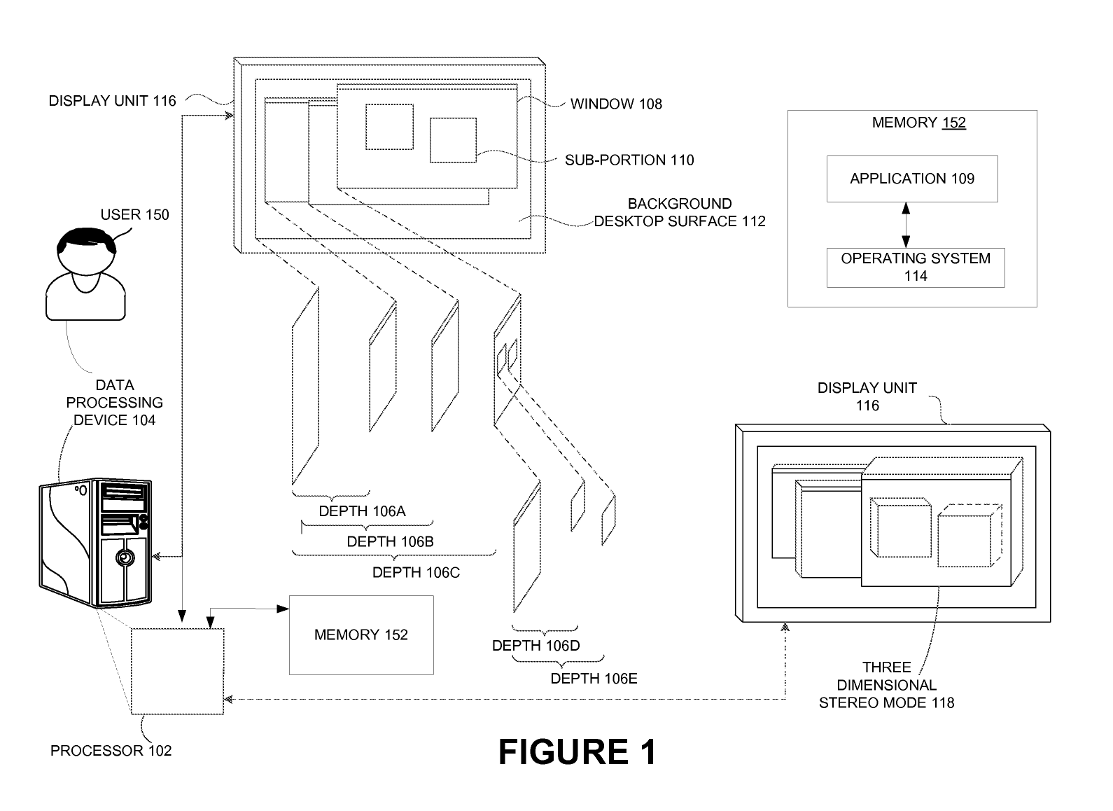

FIG. 1 shows a data processing device 104, according to one or more embodiments. In one or more embodiments, data processing device 104 may represent various forms of a digital computer including but not limited to a laptop, a desktop, a tablet, a workstation and a personal digital assistant, or, a mobile device (e.g., mobile phone). In one or more embodiments, data processing device 104 may include a processor 102 (e.g., Central Processing Unit (CPU), Graphics Processing Unit (GPU)) communicatively coupled to a memory 152 (e.g., non-volatile memory, volatile memory). In one or more embodiments, data processing device 104 may include a display unit 116 configured to render data processed through processor 102 thereon.

In one or more embodiments, data processing device 104 may execute an application 109 (e.g., installed on data processing device 104) and an operating system 114 thereon. In one or more embodiments, application 109 may be stored in memory 152 to be executed on data processing device 104; operating system 114 is also shown in FIG. 1 as being stored in memory 152. In one or more embodiments, the execution of application 109 may cause opening of one or more windows (e.g., windows 108) associated therewith. In one or more embodiments, a window 108 may include sub-portions (e.g., window elements; sub-portions 110) therein.

In one or more embodiments, in conjunction with a display driver component (e.g., software driver; not shown in FIG. 1) of processor 102, processor 102 may cause an active window 108 and/or a sub-portion 110 thereof to be presented in a three-dimensional (3D) stereo mode, as will be discussed herein. In one or more embodiments, the display driver component may be configured to initiate acquisition of one of more depth parameter(s) of window 108 of application 109 and/or sub-portion 110 of window 108 through processor 102. In one example embodiment, the one or more depth parameter(s) may be an absolute value of a depth and/or a parameter related thereto of window 108 that operating system 114 provides.

In one or more embodiments, based on the acquired one or more depth parameter(s), processor 102 may be configured to determine the depth (e.g., any one of depth(s) 106A-C for the example three windows 108) of window 108 relative to a background desktop surface 112 provided by operating system 114. Additionally or alternately, in one or more embodiments, based on the acquired one or more depth parameter(s), processor 102 may be configured to determine the depth (e.g., any one of depth(s) 106D-E for the example two sub-portion(s) 110) of sub-portion 110 of window 108 relative to window 108. In one or more embodiments, once the depth of window 108 relative to background desktop surface 112 and/or the depth of sub-portion 110 relative to window 108 is determined, processor 102 may be configured to enable rendering of window 108 and/or sub-portion 110 in a 3D stereo mode 118 based on the aforementioned determination on display unit 116.

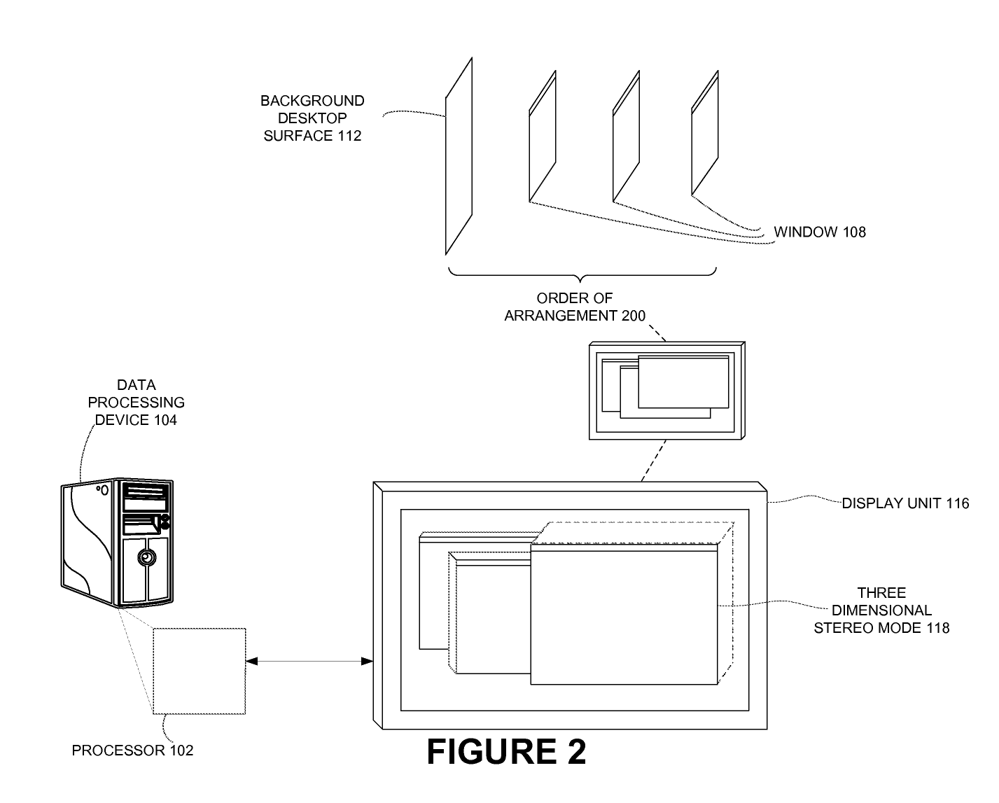

In one or more embodiments, the 3D “depth” effect may enable a user 150 of data processing device 104 distinguish between portions of application 109 and/or a desktop provided by operating system 114. Additionally, in one or more embodiments, the 3D effect may enable user 150 to distinguish between sub-portions of window 108 of application 109. FIG. 2 shows rendering of a number of windows 108 in 3D stereo mode 118, according to one or more embodiments. In one or more embodiments, windows 108 of application 109 may be ordered based on depths thereof relative to background desktop surface 112. In one or more embodiments, the aforementioned ordering may be performed through processor 102. In one or more embodiments, based on the determined order of arrangement 200, processor 102 may enable rendering of windows 108 on display unit 116 in 3D stereo mode 118.

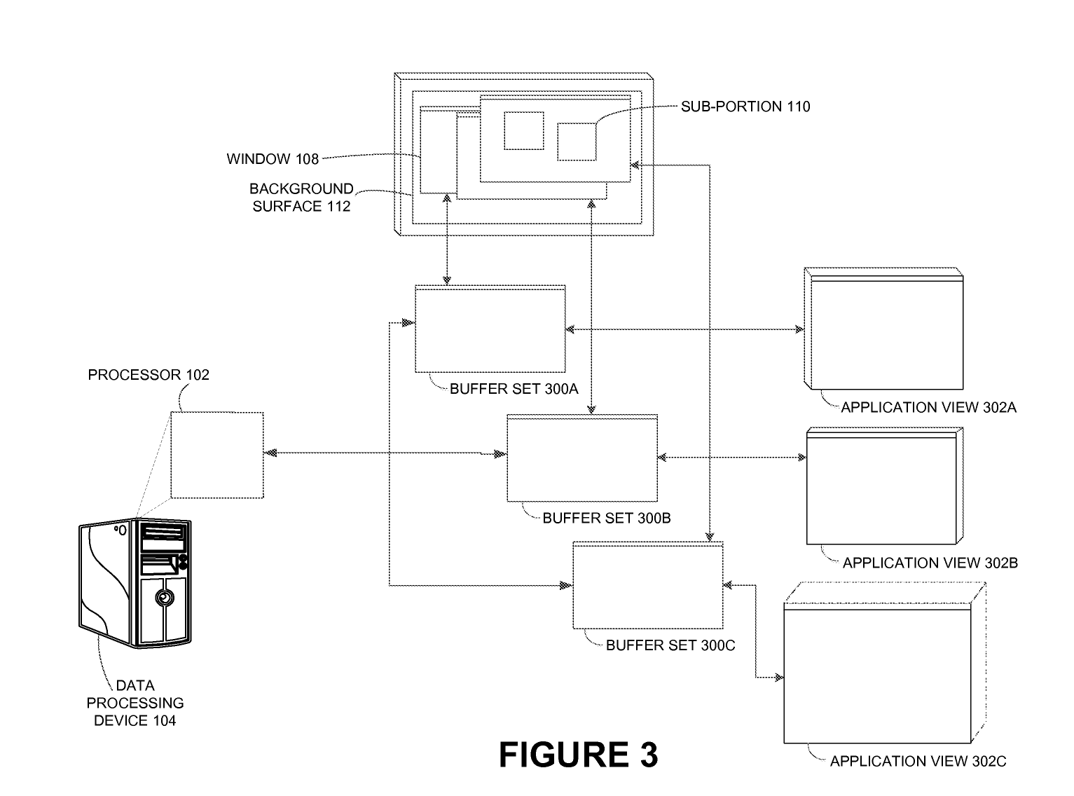

In one or more embodiments, sub-portion 110 of window 108 may be rendered at a depth different from a remaining portion of window 108 to enable clear distinction thereof. FIG. 3 shows rendering of example application view(s) 302A-C associated with window(s) 108 on data processing device 104. In one or more embodiments, application view(s) 302A-C may be rendered through processor 102 into separate buffer set(s) 300A-C (e.g., stored in memory 152). In one or more embodiments, processor 102 may then enable compositing of separate buffer set(s) 300A-C together through operating system 114 in conjunction with the display driver component. Thus, in one or more embodiments, application view(s) 302A-C may provide desired 3D effect(s) to user 150 in the rendered state.

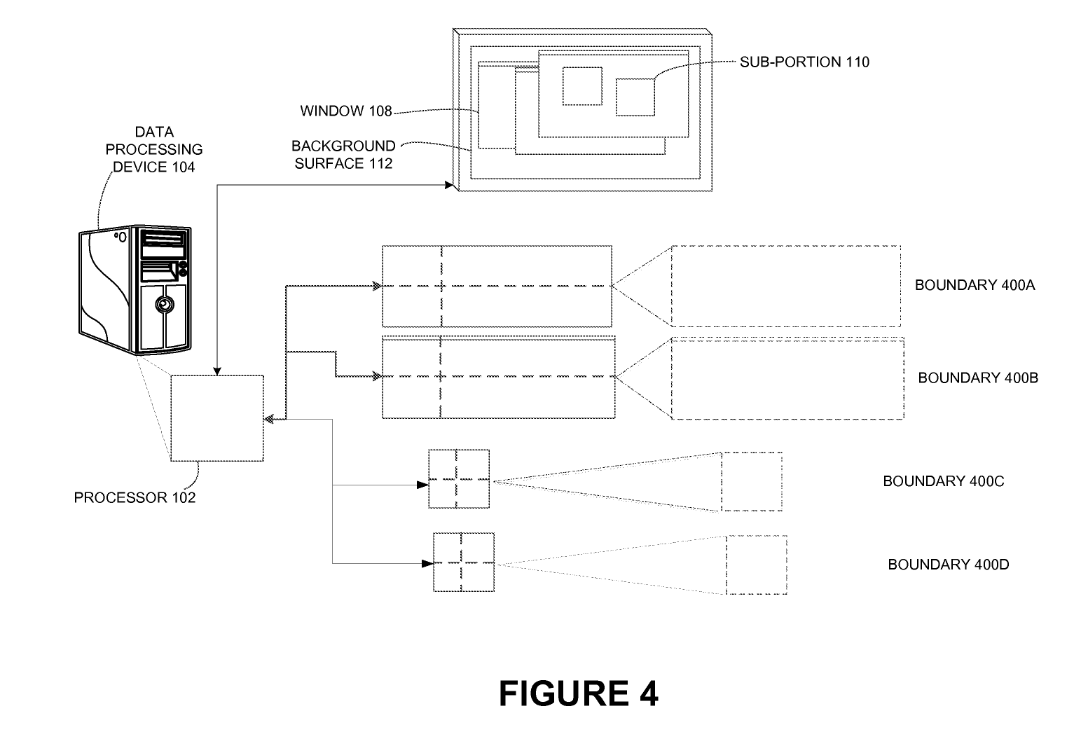

FIG. 4 shows distinguishing between boundaries of window(s) 108 of FIG. 2 and a boundary of background desktop surface 112 and between boundaries of sub-portion(s) performed through processor 102 as part of the rendering of application view(s) 302A-C on display unit 116. In one or more embodiments, as window(s) 108 and/or sub-portion(s) 110 thereof may overlap, the distinction may involve distinguishing between a boundary (e.g., boundary 400A) of window 108, a boundary (e.g., boundary 400B) of another window 108 and a boundary (not shown) of background desktop surface 112 and/or distinguishing between a boundary (e.g., boundary 400C) of sub-portion 110 of window 108 and a boundary (e.g., boundary 400D) of another sub-portion 110 of window 108.

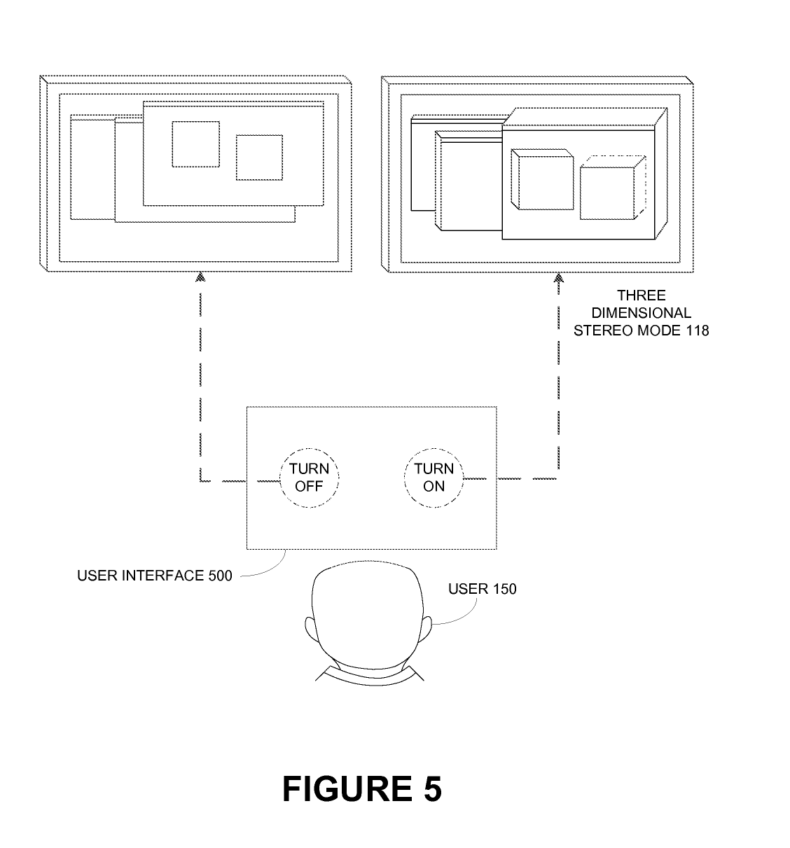

FIG. 5 shows a user interface 500 provided by application 109 and/or operating system 114, according to one or more embodiments. In one or more embodiments, user interface 500 may enable user 150 to turn on and/or turn off the rendering of window 108 and/or sub-portion 110 in 3D stereo mode 118. Further, in one or more embodiments, user 150 may be provided the capability to control depth(s) to be rendered in 3D stereo mode 118 through user interface 500. While FIG. 5 shows a virtual version of user interface 500, it is obvious that other forms (e.g., a physical form such as a button associated with data processing device 104; here user interface 500 is data processing device 104) of user interface 500 are also within the scope of the exemplary embodiments discussed herein.

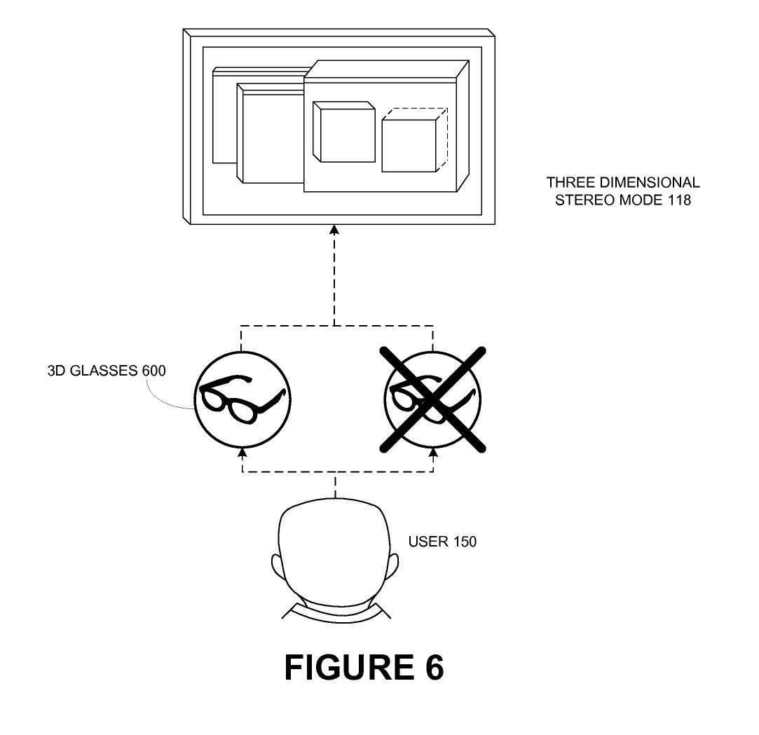

FIG. 6 shows user 150 viewing window 108 and/or sub-portion 110 using 3D glasses 600, according to one or more embodiments. In one or more embodiments, the aforementioned capability to view window 108 and/or sub-portion 110 using 3D glasses 600 may be provided through the display driver component. In one example embodiment, when 3D glasses 600 are worn, user 150 may have the capability to solely view window 108 (e.g., active window) and/or sub-portion 110 in 3D stereo mode 118. In another example embodiment, user 150 may have the capability to view window 108 and/or sub-portion 110 in 3D stereo mode 118 only after wearing 3D glasses 600.

In one or more embodiments, instructions associated with the display driver component may be embodied on a non-transitory medium (e.g., Compact Disc (CD), Digital Video Disc (DVD), hard drive) readable through data processing device 104. In another embodiment, the display driver component of processor 102 may be packaged with operating system 114 and/or available as a download through the Internet. Upon user 150 downloading the display driver component into data processing device 104, user 150 may install the display driver component therein.

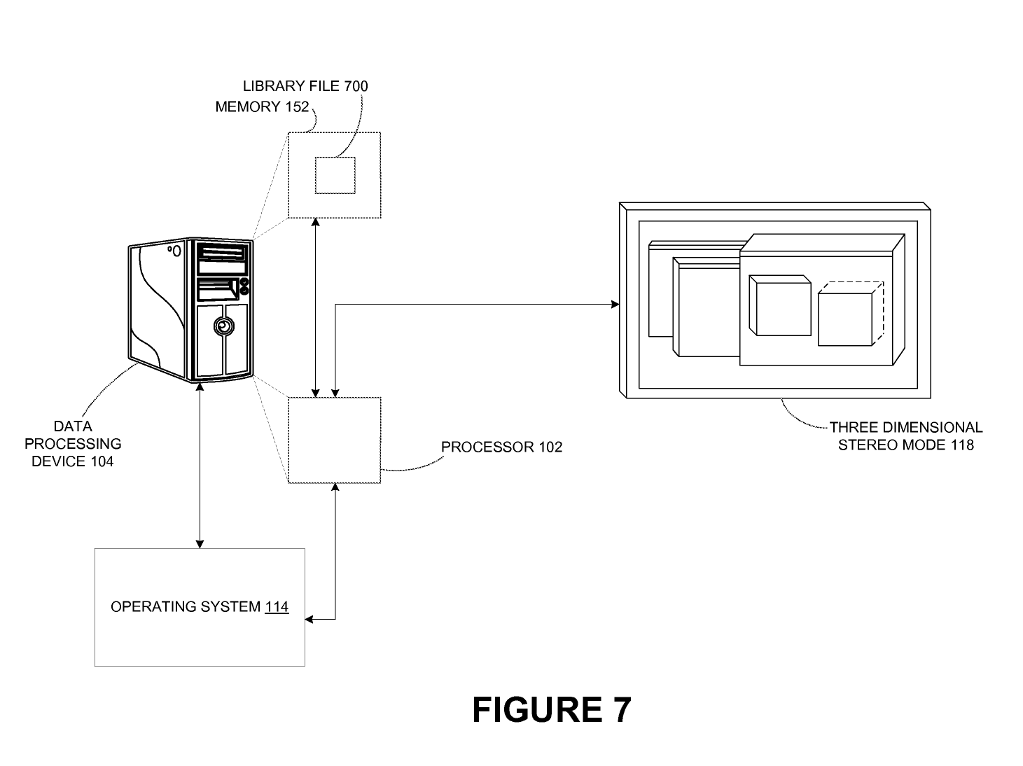

FIG. 7 shows an example alternate implementation of rendering window 108 and/or sub-portion 110 in 3D stereo mode 118. The aforementioned alternate implementation may involve invoking a library file 700 stored in memory 152. Library file 700 may be associated with enabling the rendering of window 108 and/or sub-portion 110 in 3D stereo mode 118. Library file 700 may be downloaded to memory 152 through the Internet, or, transferred thereto/installed therein through a non-transitory medium discussed above.

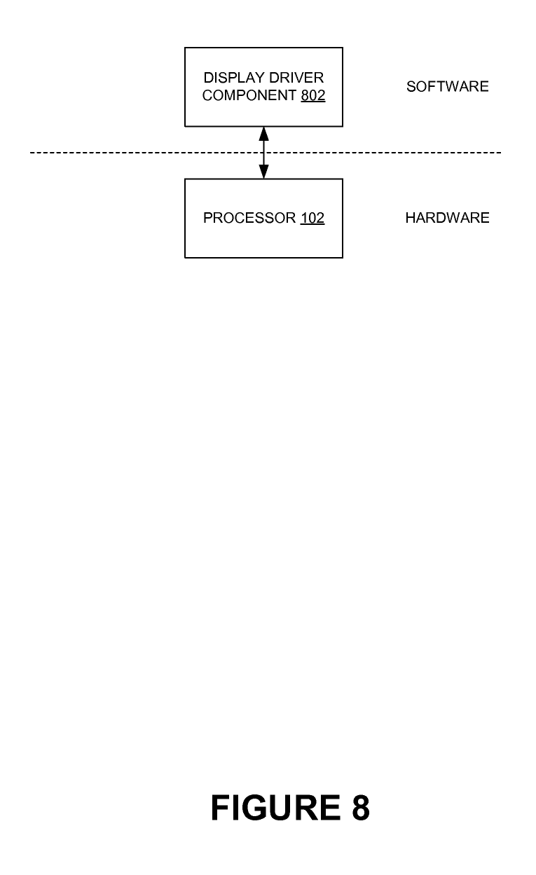

Alternately, operating system 114 may instruct the display driver component through one or more Application Programming Interface(s) (API(s)) or Display Driver Interface(s) (DDI(s)) (not shown) to enable rendering of window 108 and/or sub-portion 110 in 3D stereo mode 118. FIG. 8 shows interaction between a display driver component 802 and processor 102 (e.g., GPU), according to one or more embodiments. In one example embodiment, when user 150 clicks a window 108 and/or sub-portion 110 (or, any equivalent action that initiates the rendering of window 108 and/or sub-portion 110), display driver component 802 may be configured to initiate acquisition of one or more depth parameter(s) of window 108 and/or sub-portion 110. Based on the acquired one or more depth parameter(s), processor 102 may then determine depth 106A-E of window 108 relative to background desktop surface 112 and/or sub-portion 110 relative to window 108. Window 108 and/or sub-portion 110 may then be rendered on display unit 116 in 3D stereo mode 118 based on the determined relative depth 106A-E.

It is to be noted that concepts associated with exemplary embodiments discussed herein are different from those applied to 3D aware applications (e.g., games). In the case of 3D aware applications, depth information is already available therethrough, and may be passed onto a graphics driver. Exemplary embodiments discussed herein are also applicable to generic two-dimensional (2D) applications that are not necessarily 3D aware. Thus, exemplary embodiments discussed herein find utility in cases where application 109 may not be employing special 3D APIs provided through operating system 114/display driver component 802. In one or more embodiments, internal computation through display driver component 802 may suffice to automatically represent a desktop of data processing device 104 in 3D stereo mode 118.

Further, it is to be noted that multiple application(s) including application 109 may execute on data processing device 102, and exemplary embodiments discussed herein may serve to determine relative depths of one or more window(s) of each application through processor 102 in order to perform further processing to facilitate 3D rendering. Moreover, while exemplary embodiments are discussed with regard to 3D stereoscopic rendering, it should be noted that concepts associated therewith are also applicable to 3D rendering (e.g., 3D rendering that requires determination of relative depths) in a generic sense.

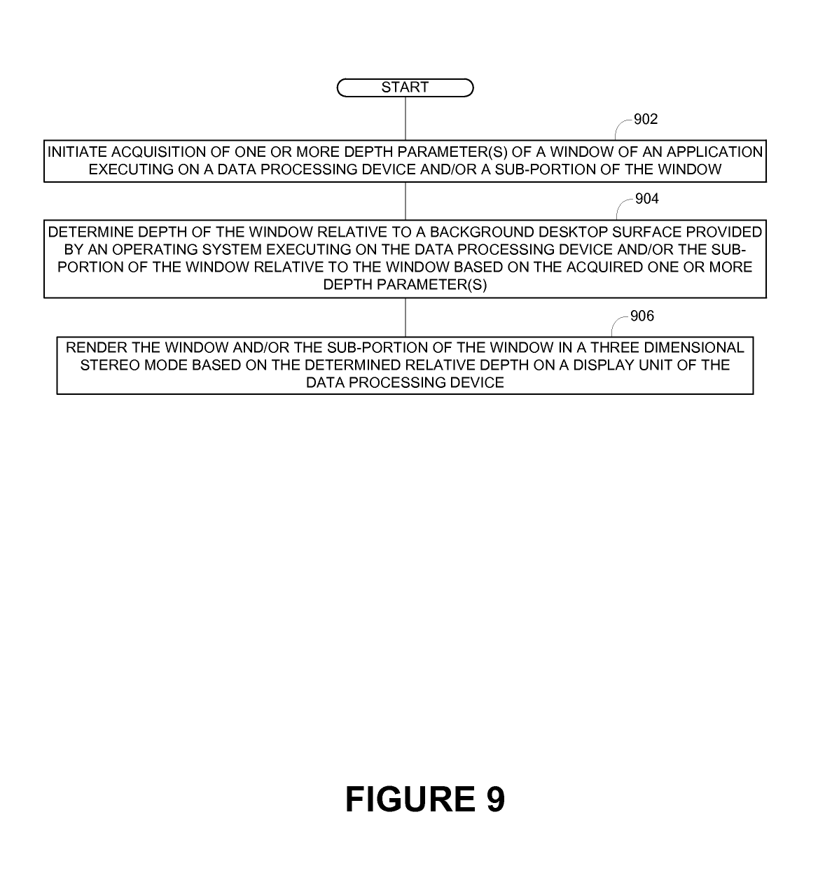

FIG. 9 shows a process flow diagram detailing the operations involved in 3D desktop rendering in data processing device 104, according to one or more embodiments. In one or more embodiments, operation 902 may involve initiating, through display driver component 802 of processor 102 of data processing device 104, acquisition of one or more depth parameter(s) of window 108 of application 109 executing on data processing device 104 and sub-portion 110 of window 108. In one or more embodiments, operation 904 may involve determining, through processor 102, depth 106A-E of window 108 relative to background desktop surface 112 provided by operating system 114 executing on data processing device 104 and/or sub-portion 110 of window 108 relative to window 108 based on the acquired one or more depth parameter(s).

In one or more embodiments, operation 906 may then involve rendering, through processor 102, window 108 and/or sub-portion 110 of window 108 in 3D stereo mode 118 based on the determined relative depth 106A-E thereof on display unit 116 of data processing device 104.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a non-transitory machine-readable medium). For example, the various electrical structure and methods may be embodied using transistors, logic gates, and electrical circuits (e.g., Application Specific Integrated Circuitry (ASIC) and/or Digital Signal Processor (DSP) circuitry).

In addition, it will be appreciated that the various operations, processes, and methods disclosed herein may be embodied in a non-transitory machine-readable medium and/or a machine accessible medium compatible with a data processing system (e.g., data processing device 104), and may be performed in any order (e.g., including using means for achieving the various operations).

Accordingly, the specification and drawings are to be regarded in an illustrative rather than a restrictive sense.

1. A method comprising:
initiating, through a display driver component of a processor of a data processing device, acquisition of at least one depth parameter of at least one of: a window of an application executing on the data processing device and a sub-portion of the window;
determining, through the processor of the data processing device, depth of the at least one of the window relative to a background desktop surface provided by an operating system executing on the data processing device and the sub-portion of the window relative to the window based on the acquired at least one depth parameter; and
rendering, through the processor of the data processing device, the at least one of the window and the sub-portion of the window in a three dimensional (3D) mode based on the determined relative depth thereof on a display unit of the data processing device.

2. The method of claim 1, wherein, when a plurality of windows is associated with the application, the method further comprises:
determining, through the processor of the data processing device, an order of arrangement of the plurality of windows based on depths thereof relative to the background desktop surface; and
rendering, through the processor of the data processing device, at least one of the plurality of windows in the 3D mode based on the determined order of arrangement of the plurality of windows on the display unit of the data processing device.

3. The method of claim 1, further comprising:
rendering, through the processor of the data processing device, the sub-portion of the window at a depth different from a remaining portion of the window.

4. The method of claim 2, further comprising:
rendering, through the processor of the data processing device, an application view associated with the window and another application view associated with another window into separate buffer sets; and
compositing, through the processor of the data processing device, the separate buffer sets together through the operating system in conjunction with the display driver component.

5. The method of claim 2, wherein rendering, through the processor of the data processing device, the at least one of the window and the sub-portion of the window in the 3D mode includes at least one of:
distinguishing between a boundary of the window, a boundary of another window and a boundary of the background desktop surface, and
distinguishing between a boundary of the sub-portion of the window and a boundary of another sub-portion of the window.

6. The method of claim 1, further comprising providing, through a user interface of at least one of the operating system, the application and the data processing device, a capability to a user of the data processing device to at least one of: at least one of turn on and turn off the rendering of the at least one of the window and the sub-portion of the window in the 3D mode, and control the determined relative depth to be rendered in the 3D mode.

7. The method of claim 1, further comprising providing, through the display driver component, a capability to a user of the data processing device to view the at least one of the window and the sub-portion of the window with 3D glasses.

8. The method of claim 1, wherein initiating, through the display driver component, the acquisition of the at least one depth parameter includes at least one of:
invoking, through the display driver component, a library file stored in a memory of the data processing device, the library file being associated with enabling the rendering of the at least one of the window and the sub-portion of the window in the 3D mode; and
instructing, through the operating system executing on the data processing device, the display driver component through at least one of: at least one Application Programming Interface (API) and at least one Display Driver Interface (DDI) to enable the rendering of the at least one of the window and the sub-portion of the window in the 3D mode.

9. A non-transitory medium, readable through a data processing device and including instructions embodied therein that are executable through the data processing device, comprising:
instructions to initiate, through a display driver component of a processor of the data processing device, acquisition of at least one depth parameter of at least one of: a window of an application executing on the data processing device and a sub-portion of the window;
instructions to determine, through the processor of the data processing device, depth of the at least one of the window relative to a background desktop surface provided by an operating system executing on the data processing device and the sub-portion of the window relative to the window based on the acquired at least one depth parameter; and
instructions to render, through the processor of the data processing device, the at least one of the window and the sub-portion of the window in a 3D mode based on the determined relative depth thereof on a display unit of the data processing device.

10. The non-transitory medium of claim 9, wherein, when a plurality of windows is associated with the application, the non-transitory medium further comprises:
instructions to determine, through the processor of the data processing device, an order of arrangement of the plurality of windows based on depths thereof relative to the background desktop surface; and
instructions to render, through the processor of the data processing device, at least one of the plurality of windows in the 3D mode based on the determined order on the display unit of the data processing device.

11. The non-transitory medium of claim 9, further comprising:
instructions to render, through the processor of the data processing device, the sub-portion of the window at a depth different from a remaining portion of the window.

12. The non-transitory medium of claim 10, further comprising:
instructions to render, through the processor of the data processing device, an application view associated with the window and another application view associated with another window into separate buffer sets; and
instructions for compositing, through the processor of the data processing device, the separate buffer sets together through the operating system in conjunction with the display driver component.

13. The non-transitory medium of claim 10, wherein the instructions to render, through the processor of the data processing device, the at least one of the window and the sub-portion of the window in the 3D mode includes instructions to at least one of:
distinguish between a boundary of the window, a boundary of another window and a boundary of the background desktop surface, and
distinguish between a boundary of the sub-portion of the window and a boundary of another sub-portion of the window.

14. The non-transitory medium of claim 9, further comprising instructions to provide, through a user interface of at least one of the operating system, the application and the data processing device, a capability to a user of the data processing device to at least one of: at least one of turn on and turn off the rendering of the at least one of the window and the sub-portion of the window in the 3D mode, and control the determined relative depth to be rendered in the 3D mode.

15. The non-transitory medium of claim 9, further comprising instructions to provide, through the display driver component, a capability to a user of the data processing device to view the at least one of the window and the sub-portion of the window with 3D glasses.

16. The non-transitory medium of claim 9, wherein the instructions to initiate, through the display driver component, the acquisition of the at least one depth parameter includes at least one of:
instructions to invoke, through the display driver component, a library file stored in a memory of the data processing device, the library file being associated with enabling the rendering of the at least one of the window and the sub-portion of the window in the 3D mode; and
instructions to instruct, through the operating system executing on the data processing device, the display driver component through at least one of: at least one API and at least one DDI to enable the rendering of the at least one of the window and the sub-portion of the window in the 3D mode.

17. A data processing device comprising:
a memory;
a processor communicatively coupled to the memory; and
a display driver component of the processor to initiate acquisition of at least one depth parameter of at least one of: a window of an application executing on the data processing device and a sub-portion of the window, the processor being configured to:
determine depth of the at least one of the window relative to a background desktop surface provided by an operating system executing on the data processing device and the sub-portion of the window relative to the window based on the acquired at least one depth parameter, and
render the at least one of the window and the sub-portion of the window in a 3D mode based on the determined relative depth thereof on a display unit of the data processing device.

18. The data processing device of claim 17, wherein, when a plurality of windows is associated with the application, the processor is further configured to:
determine an order of arrangement of the plurality of windows based on depths thereof relative to the background desktop surface, and
render at least one of the plurality of windows in the 3D mode based on the determined order on the display unit of the data processing device.

19. The data processing device of claim 17, wherein the processor is further configured to:
render the sub-portion of the window at a depth different from a remaining portion of the window.

20. The data processing device of claim 17, wherein the processor is further configured to:
render an application view associated with the window and another application view associated with another window into separate buffer sets, and
enable compositing of the separate buffer sets together through the operating system in conjunction with the display driver component.
